(19) United States
(12) Patent Application Publication
(10) Pub. No.: US 2004/0150513 A1
(43) Pub. Date: Aug. 5, 2004

(54) Vehicle with alighting passenger signaling capability

(76) Inventor: Chung-Tsai Cheng, Kaohsiung City (TW)

Correspondence Address: LADAS & PARRY, 224 SOUTH MICHIGAN AVENUE, SUITE 1200, CHICAGO, IL, 60604, US

(21) Appl. No.: 10/355,370

(22) Filed: Jan. 31, 2003

(51) Int. Cl. B60R 25/10

(52) U.S. Cl. 340/426.28

(57) ABSTRACT

A vehicle includes a door lock apparatus for locking and unlocking vehicle doors, a door status detector for detecting opening and closing movement of the vehicle doors, an alarm actuator for generating an alarm-actuating signal, and an alarm unit for generating an alarm output. A controller is responsive to the alarm-actuating signal from the alarm actuator so as to control the door lock apparatus to ensure that the vehicle doors are locked, activate the alarm unit to generate the alarm output, and to subsequently control the door lock apparatus to unlock the vehicle doors after a predetermined time period has elapsed since activation of the alarm unit. The controller subsequently terminates activation of the alarm unit upon detection by the door, status detector of opening and closing movement of the vehicle doors, indicative of a condition that a passenger has alighted the vehicle.

### BACKGROUND OF THE INVENTION

1. Field of the Invention

The invention relates to a vehicle, more particularly to a vehicle capable of signaling an alighting passenger.

2. Description of the Related Art

For precautionary measures, before a driver or passenger opens a vehicle door to alight a vehicle, it is necessary to observe whether the front and rear of the vehicle are clear of pedestrians and other moving vehicles. Negligence of the aforesaid precautionary measures can arise in accidents as a result of unexpected collision.

### SUMMARY OF THE INVENTION

Therefore, the object of the present invention is to provide a vehicle capable of signaling an alighting passenger for improved safety.

Accordingly, a vehicle of this invention comprises:

a vehicle body having vehicle doors;

a door lock apparatus operable so as to lock and unlock the vehicle doors;

a door status detector capable of detecting opening and closing movement of the vehicle doors;

an alarm actuator mounted in a passenger room of the vehicle body and operable so as to generate an alarm-actuating signal;

an alarm unit mounted on the vehicle body and operable so as to generate an alarm output; and

a controller coupled to the door lock apparatus, the door status detector, the alarm actuator and the alarm unit.

The controller receives the alarm-actuating signal from the alarm actuator and, in response to the alarm-actuating signal, controls the door lock apparatus to ensure that the vehicle doors are locked, activates the alarm unit to generate the alarm output, and subsequently controls the door lock apparatus to unlock the vehicle doors after a predetermined time period has elapsed since activation of the alarm unit.

The controller subsequently terminates activation of the alarm unit upon detection by the door status detector of opening and closing movement of the vehicle doors, indicative of a condition that a passenger has alighted the vehicle.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic block diagram of a preferred embodiment of a vehicle according to the present invention;

FIG. 2 is a top view of the preferred embodiment;

FIG. 3 is a side view of the preferred embodiment; and

FIG. 4 is a flowchart to illustrate a passenger alighting operation of the preferred embodiment.

### DETAILED DESCRIPTION OF THE PREFERRED EMBODIMENT

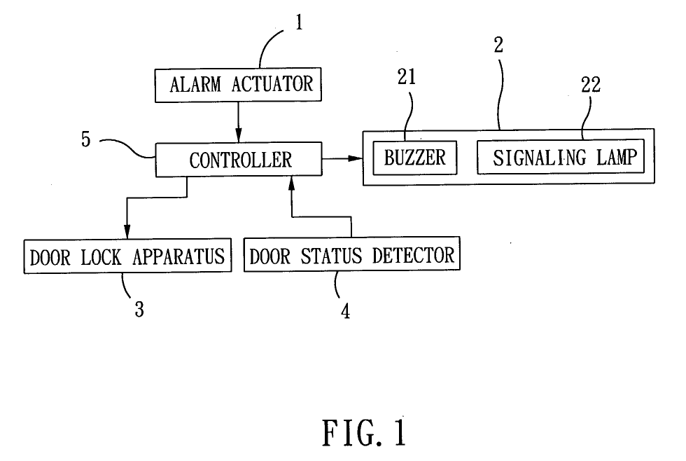

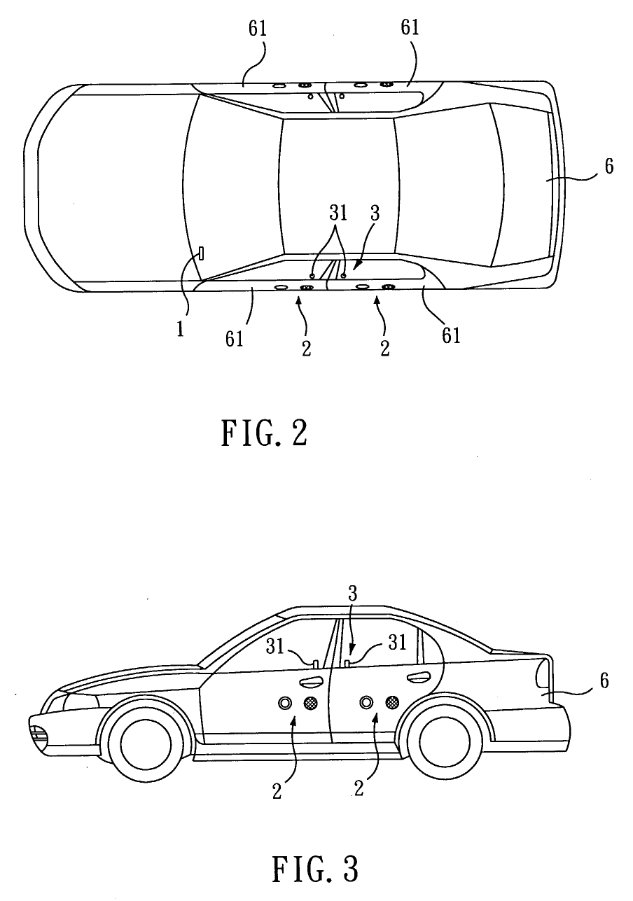

Referring to FIGS. 1, 2 and 3, the preferred embodiment of a vehicle according to the present invention is shown to include a vehicle body 6 having vehicle doors 61, an alarm actuator 1, an alarm unit 2, a door lock apparatus 3, a door status detector 4, and a controller 5.

The door lock apparatus 3 includes a lock device 31 for each of the vehicle doors 61. Each lock device 31 operates in a conventional manner so as to lock and unlock the respective vehicle door 61.

The door status detector 4 is capable of detecting opening and closing movement of the vehicle doors 61 in a conventional manner.

The alarm actuator 1 is mounted in a passenger room of the vehicle body 6, and is operable so as to generate an alarm-actuating signal. In this embodiment, the alarm actuator 1 is in the form of a manually operable switch.

The alarm unit 2 is mounted on the vehicle body 6 and is operable so as to generate an alarm output. In this embodiment, the alarm unit 2 includes a set of buzzers 21, each of which is mounted on a respective one of the vehicle doors 61 and is operable so as to generate an audible alarm output, and a set of signaling lamps 22, each of which is mounted on a respective one of the vehicle doors 61 and is operable so as to generate a flashing alarm output.

The controller 5 is coupled to the door lock apparatus 3, the door status detector 4, the alarm actuator 1, and the alarm unit 2.

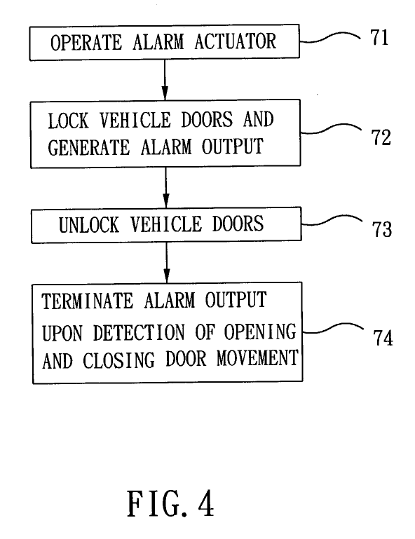

FIG. 4 illustrates a passenger alighting operation of the preferred embodiment. The operation begins at step 71, where the alarm actuator 1 is operated when the vehicle is parked and the vehicle engine is still running. Accordingly, an alarm-actuating signal is generated and is provided to the controller 5. Thereafter, at step 72, the controller 5 responds to the alarm-actuating signal from the alarm actuator 1 by controlling the door lock apparatus 3 to ensure that the vehicle doors 61 are locked and by activating the alarm unit 2 to generate the alarm output. Subsequently, at step 73, the controller 5 controls the door lock apparatus 3 to unlock the vehicle doors 61 after a predetermined time period has elapsed since activation of the alarm unit 2. The predetermined time period is preset and is preferably three to five seconds in duration to render a sufficient alarming effect. A passenger can alight the vehicle at this time.

At step 74, at least one of the vehicle doors 61 is opened by a passenger or by passengers alighting the vehicle. The controller 5 continues to activate the alarm unit 2 for continued generation of the audible alarm output by the buzzers 21 and the flashing alarm output by the signaling lamps 22 until the door status detector 4 detects opening and subsequent closing movement of the vehicle doors 61, indicative of a condition that the passenger or passengers have alighted the vehicle. The controller 5 then terminates activation of the alarm unit 2 when the latter condition is met.

In view of the forced locking of the vehicle doors 61 and the generation of an alarm output before passengers can alight the vehicle, safety can be improved when the vehicle of the present invention is in use.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A vehicle comprising:
a vehicle body having vehicle doors;
a door lock apparatus operable so as to lock and unlock said vehicle doors;
a door status detector capable of detecting opening and closing movement of said vehicle doors;
an alarm actuator mounted in a passenger room of said vehicle body and operable so as to generate an alarm-actuating signal;
an alarm unit mounted on said vehicle body and operable so as to generate an alarm output; and
a controller coupled to said door lock apparatus, said door status detector, said alarm actuator and said alarm unit;
wherein said controller receives the alarm-actuating signal from said alarm actuator and, in response to the alarm-actuating signal, controls said door lock apparatus to ensure that said vehicle doors are locked, activates said alarm unit to generate the alarm output, and subsequently controls said door lock apparatus to unlock said vehicle doors after a predetermined time period has elapsed since activation of said alarm unit; and
wherein said controller subsequently terminates activation of said alarm unit upon detection by said door status detector of opening and closing movement of said vehicle doors, indicative of a condition that a passenger has alighted said vehicle.

2. The vehicle as claimed in claim 1, wherein said alarm actuator includes a manually operable switch.

3. The vehicle as claimed in claim 1, wherein said alarm unit includes a buzzer for generating an audible alarm output.

4. The vehicle as claimed in claim 1, wherein said alarm unit includes a signaling lamp for generating a flashing alarm output.

5. The vehicle claimed in claim 1, wherein said alarm unit is mounted on said vehicle doors.
